(19) United States
(12) Patent Application Publication
(10) Pub. No.: US 2016/0286835 A1
(43) Pub. Date: Oct. 6, 2016

(54) FEED ADDITIVE CONTAINING BIOGAS RESIDUES FOR COWS

(71) Applicant: ZHEJIANG AGRICULTURAL AND FORESTRY UNIVERSITY, Linan, Zhejiang (CN)

(72) Inventors: FANGBO YU, Linan, Zhejiang (CN); SHENGDAO SHAN, Linan, Zhejiang (CN); LINPIN LUO, Linan, Zhejiang (CN); ZHENGQIAN YE, Linan, Zhejiang (CN); LIBO GUAN, Linan, Zhejiang (CN)

(21) Appl. No.: 14/401,516

(22) PCT Filed: Apr. 2, 2014
(86) PCT No.: PCT/CN2014/074586

§ 371 Date: Nov. 15, 2014

(30) Foreign Application Priority Data
May 24, 2013 (CN) 201310204017.4

(51) Int. Cl. A23K 10/38; A23K 10/30; A23K 40/10; A23K 50/10

(52) U.S. Cl. CPC A23K 10/38; A23K 50/10; A23K 10/30; A23K 40/10

(57) ABSTRACT

The present invention belongs to the field of feed, and particularly relates to a feed additive containing biogas residues for cows. The feed additive for cows is prepared by mixing the following components in parts by weight: 20-50 parts of biogas residues, 15-28 parts of radix astragali residues, 10-12 parts of apple pomace, 3-6 parts of purple perilla, 4-8 parts of eucommia leaves, 3-8 parts of purslane and 0-1 part of maca powder. The biogas residues are resulting products from anaerobic fermentation of distillers' grains left by using cassava or sweet potatoes as raw materials for fermentation, and are then moisture removed by mechanical extrusion, dried by exposure to the sun and finally crushed by a crusher for use. The scientifically-formulated and nutrient-rich feed additive provided by the present invention enhances the immunity of cows, decreases the risk of various diseases or infections during the feeding process, and reduces the use of drugs. The accumulation of active substances of the raw materials in cow tissues also improves the milk yield.

### TECHNICAL FIELD OF THE INVENTION

The present invention belongs to the field of feed, and particularly relates to a feed additive containing biogas residues for cows.

### BACKGROUND OF THE INVENTION

As resulting products from anaerobic fermentation of organic wastes, biogas residues are regarded as one of valuable resources and rich in soluble inorganic salt nutrient substances and various biochemical products (for example, nitrogen, phosphorus, potassium, boron, copper, manganese, calcium, zinc and other microelements, and various amino acids), and are thus prone to uptake by living beings and crops. In addition, the biogas residues, containing 23.5-35.8% of protein and vitamin B₁₂ of 17.6 mg/kg (dry weight), may be used as feed after processed, with considerable nutritive and economic benefits.

The biogas residues, nutrients contained in which are not only nutrient elements necessary for the growth of crops but also main nutrient substances in feed used for livestock feeding and aquaculture, are somewhat valuable in resource utilization. Making full use of biogas residues eases the crisis of resources to a certain extent and makes waste profitable, as well as brings considerable economic and social benefits while reducing ambient pollution burden. Recently, some large wineries and alcohol plants (e.g., factories in Mianzhu city in Sichuan and Linyi city in Shandong, etc.) have invested heavily in anaerobic fermentation facilities, and have constructed a number of large-scale biogas projects using distillers' grains as raw materials by actively utilizing the biogas anaerobic fermentation technology, with considerable yield of biogas residues. However, these resulting products from fermentation have not been utilized reasonably and effectively, thereby resulting in the waste of resources. At present, as the overall supply-demand relationship in the field of feed resources presents the characteristics of concentrated feed shortage, protein feed shortage, green feed shortage, and insufficiency of total yield and so forth, biogas residues which have not been widely applied in the field of feed need to be urgently exploited and utilized.

### SUMMARY OF THE INVENTION

An objective of the present invention is to provide a feed additive containing biogas residues for cows, which has adequate raw materials and nutrient-rich components in the raw materials and improves the utilization ratio of resources.

To solve the technical problem, the present invention employs the following technical solutions.

An feed additive containing biogas residues for cows is provided, being prepared by mixing the following components in parts by weight: 20-50 parts of biogas residues, 15-28 parts of radix astragali residues, 10-12 parts of apple pomace, 3-6 parts of purple perilla, 4-8 parts of eucommia leaves, 3-8 parts of purslane, and 0-1 part of maca powder; and the biogas residues are resulting products from anaerobic fermentation of distillers' grains left by using cassava or sweet potatoes as raw materials for fermentation, and are then moisture removed by mechanical extrusion, dried by exposure to the sun and finally crushed by a crusher for use.

In the present invention, as wastes respectively from biogas anaerobic fermentation and traditional Chinese medicine production, the biogas residues and radix astragali residues are easy to get, low in price and cost, and thus suitable for large-scale production. The raw materials of the feed additive conform to the national standards for the feed industry. As residues of fresh apples after crushed, squeezed and extraction of juice, the apple pomace, mainly consisting of peels, kernels and residual pulp and containing soluble sugar, vitamins, mineral substances, cellulose and other rich nutrients, is a good feed resource. The addition of the apple pomace in the feed additive containing biogas residues for cows provided by the present invention realizes the recycling of resources, improves the utilization ratio of waste apple pomace, and makes the formula in the present invention more nutrient-rich and scientific. As the resulting products from anaerobic fermentation and free of parasites and hazardous substances, the biogas residues are highly safe as feed additives. The radix astragali residues still contain a certain amount of astragaloside as well as saponins, flavone, polysaccharide, amino acids, microelements and the like, which, when constituting the component A of the present invention together with the biogas residues and other components, play a role of complementation and regulation in the aspect of nutrients. Meanwhile, a new idea is also provided to solve the problem of the recycling of three kinds of residues.

Tender and nutrient-rich leaves of purple perilla contain protein, fat, soluble sugar, dietary fiber, carotene, vitamin B1, vitamin B2, vitamin C, potassium, calcium, phosphorus, iron, manganese, selenium and other components. In addition, the leaves contain volatile oil containing perillaldehyde, perillyl alcohol, menthone, menthol, eugenol, egomaketon and the like, and thus have a peculiar fragrance and preservative effects. It was found by studies that, purple perilla with uniform parts has a good anticancer effect, especially its leaves. Oleanolic acid is an efficient natural anticancer agent which protects against tumors and also has anti-inflammatory, sedative, cardiotonic, diuresis, immunity supporting, anti-hyperlipemia and growth of cancer cells inhibition properties.

The eucommia leaves contain chlorogenic acid having a broad range of antibacterial activities.

The purslane, containing protein, fat, various vitamins, minerals and other nutrients, is edible and has medicinal benefits. The purslane contains vitamin A like substances which can maintain physiological functions of epithelial tissues including skin, mucosa, cornea and the like. As a kind of wild vegetables, the purslane is easy to get and effective in antibacterial activities, and works well in preventing and treating enteritis, coccidium and the like.

Maca powder is dry powder of the plant maca. Chemical components in the dry maca roots are as follows: above 10% of protein, 59% of carbohydrate, 8.5% of fibers, rich zinc, calcium, iron, titanium, rubidium, potassium, sodium, copper, manganese, magnesium, strontium, phosphorus, iodine and other mineral substances, as well as vitamins C, B1, B2, B6, A, E, B12 and B5, but low fat, of which the majority is unsaturated fatty acid, where the content of linoleic acid and linolenic acid is above 53%. The natural active components include alkaloid, glucosinolate, and decomposition products thereof (i.e., benzyl isothiocyanate, sterol, polyphenols and the like). With multiple biologically active substances, maca may be used as a physical strength enhancer.

In the present invention, the addition of radix astragali residues and purple perilla may effectively enhance the immunity of cows, thereby avoiding the waste of drug dregs and reducing the use of medicaments in feed for cows. The further formulation of eucommia leaves and purslane in proportion makes the feed additive have broad-spectrum anti-inflammatory capabilities, thereby enhancing the immunity of cows and reducing the risk of various infections and diseases. Meanwhile, a proper amount of maca powder stimulates the cows to enhance the milk yield and maintain a better mental state. The active substances of each component are accumulated in cow muscle tissues, so that the milk yield is improved. Mixed in proper proportion, the components have the effects of nourishing blood, clearing and activating the channels and collaterals, promoting lactation and improving immunity. Due to multiple nutrients and biological activity, the appetite of cows is promoted and the digestive absorption and metabolism of cows are improved, so that the lactation efficiency of cows is improved, and there is long-term aftereffect onto the adjustment of cows.

Preferably, the feed additive containing biogas residues for cows is prepared by mixing the following components in parts by weight: 48 parts of biogas residues, 25 parts of radix astragali residues, 10 parts of apple pomace, 6 parts of purple perilla, 8 parts of eucommia leaves, 6 parts of purslane and 0.5 parts of maca powder.

Preferably, the feed additive containing biogas residues for cows is prepared by mixing the following components in parts by weight: 37 parts of biogas residues, 28 parts of radix astragali residues, 12 parts of apple pomace, 4 parts of purple perilla, 6 parts of eucommia leaves, 8 parts of purslane and 1 part of maca powder.

A method for preparing the feed additive containing biogas residues for cows is provided, including the following steps of: a. mixing in proportion and then crushing the purple perilla, eucommia leaves and purslane, controlling the granularity below 10 mm, and baking or air-drying until the water content is lower than 12%; and b. mixing the mixture obtained in step a with the biogas residues, radix astragali residues and apple pomace, dying and then adding the maca powder to obtain the product.

As a feed additive, the feed additive containing biogas residues for cows provided by the present invention may be mixed with the basic ration of cows for feeding cows. The mixing ratio of the feed additive containing biogas residues for cows provided by the present invention is generally 20%-60% of the basic ration, optimally about 36%.

The present invention has the following beneficial effects: by feeding cows with the feed additive containing biogas residues for cows provided by the present invention, not only the conventional feed is saved, but also the quantity of drugs and the cost of feed may be both effectively reduced. The scientifically-formulated and nutrient-rich feed additive containing biogas residues for cows enhances the immunity of cows, decreases the risk of various diseases or infections during the feeding process, and reduces the use of drugs. The accumulation of active substances of the raw materials in cow tissues also improves the milk yield.

### DETAILED DESCRIPTION OF THE INVENTION

The technical solutions of the present invention will be further described as below with reference to specific embodiments. It should be understood that the implementation of the present invention is not limited to the following embodiments, and any form of alternations and/or changes made to the present invention shall fall into the protection scope of the present invention.

In the present invention, unless otherwise specifically stated, all the part and percentage are units of weight, and all equipment and raw materials may be purchased from the market or common in the industry. The biogas residues as used in the following embodiments are resulting products from anaerobic fermentation of distillers' grains left by wineries or alcohol plants brewing wines using cassava or sweet potatoes as raw materials, and are then moisture removed by mechanical extrusion for later use. The pH of the biogas slurry fluctuates from 6.5 to 7.5.

### Embodiments 1-5

The biogas residues are oriented from large-scale anaerobic fermentation equipment normal in both operation and yield by using distillers' grains as raw materials. The pH of the biogas slurry is within a range of 6.5 to 7.5. The thoroughly decomposed biogas residues charged and discharged every day are moisture removed by mechanical extrusion, then uniformly paved in a thickness of 5-10 cm, dried by exposure to the sun and finally crushed by a crusher for later use. The results of testing show the constituents of the biogas residues, referring to Table 1.

TABLE 1
Constituents of biogas residues

| | | Total | Total | Total |
|---|---|---|---|---|
| | Organic matter | nitrogen | phosphorus | potassium |
| Sample | (%) | (%) | (%) | (%) |
| Biogas residues | 36.2-49.9 | 0.78-1.61 | 0.39-0.71 | 0.61-1.29 |

An feed additive containing biogas residues for cows is provided, being prepared by mixing the raw materials as shown in Table 2.

TABLE 2
(unit: kg)

| Raw materials | Embodiment 1 | Embodiment 2 | Embodiment 3 | Embodiment 4 | Embodiment 5 |
|---|---|---|---|---|---|
| Biogas residues | 48.0 | 37 | 20.8 | 50.0 | 48.0 |
| Radix astragali | 25.0 | 28.0 | 18.6 | 15.0 | 25.0 |
| residues | | | | | |
| Apple pomace | 10.0 | 12.0 | 10.0 | 11.0 | 10.0 |
| Purple perilla | 6.0 | 4.0 | 3.5 | 3.0 | 6.0 |
| Eucommia leaves | 8.0 | 6.0 | 4.0 | 5.0 | 8.0 |
| Purslane | 6.0 | 8.0 | 3.5 | 3.0 | 6.0 |
| Maca powder | 0.5 | 1.0 | 0.6 | 1.0 | 0 |

The following preparation steps are included:

a. mixing in proportion and then crushing the purple perilla, eucommia leaves and purslane, controlling the granularity below 10 mm, and baking or air-drying until the water content is lower than 12%; and

b. mixing the mixture obtained in step a with the biogas residues, radix astragali residues and apple pomace, dying and then adding the maca powder to obtain the product.

Animal testing: cow feeding experiment

To test the influences of the feed additive containing biogas residues for cows provided by the present invention on the milk yield of cows, the following testing method is employed for testing. In this experiment, healthy, size-uniform and normally-milking cows were selected, then fed by the conventional feeding method and randomly divided into a control group, a test group 1 and a test group 2, each having 25 cows, and this experiment was repeated twice (totally, 180 cows). The cows in the test group 1 were fed with a mixture of the feed additive containing biogas residues for cows as prepared in Embodiment 1 of the present invention and the conventional feed for cows (components include 47.2% of corn, 28.3% of soybean cake, 18.9% of bran, 3.3% of calcium phosphate and 2.3% of salt), where the feed additive containing biogas residues for cows makes up about 36% of the total feed weight, the cows in the test group 2 were fed with the feed additive containing biogas residues for cows as prepared in Embodiment 5 of the present invention and the conventional feed for cows, while the cows in the control group were fed with conventional feed for cows (the components are the same as that in the conventional feed for cows in the test groups). This experiment lasted for 60 days. The milk yield of each cow in each group per day was accurately weighted and recorded, and averaging was performed every ten days, referring to Table 3. On the 58^{th} day of the experiment, the quality of milk of each cow in each group was detected, and 30 ml of milk sample was tested by a milk component analyzer thus to measure the contents of milk fat, lactoprotein, lactose and other components in the milk. The results of this experiment refer to Table 4.

TABLE 3
Influence of the feed additive of the present invention on the milk yield of
cows

| Item | | Control group | Test group 1 | Test group 2 |
|---|---|---|---|---|
| Average | First | 18.5 ± 0.7 a | 18.6 ± 0.9 a | 18.6 ± 0.3 a |
| milk | ten days | | | |
| yield (kg/per | 10-20 days | 19.2 ± 0.2 b | 19.8 ± 0.1 a | 19.7 ± 0.2 b |
| cow per day) | 20-30 days | 19.4 ± 0.2 b | 20.3 ± 0.1 a | 20.2 ± 0.3 a |
| | 30-40 days | 19.6 ± 0.7 b | 21.9 ± 0.3 a | 21.6 ± 0.2 a |
| | 40-50 days | 19.9 ± 0.4 b | 22.5 ± 0.2 a | 22.0 ± 0.3 a |
| | 50-60 days | 19.3 ± 0.6 c | 23.2 ± 0.3 a | 22.2 ± 0.1 b |

Note:
The numerical values in this table are averages, and, different letters in a same line refer to significant differences at p = 0.05 by Duncan's new multiple range method (similarly hereinafter).

TABLE 4
Influence of the feed additive of the present invention on the quality of
milk from cows

| Item | Control group | Test group 1 | Test group 2 |
|---|---|---|---|
| Milk fat (%) | 3.65 ± 0.02 b | 3.87 ± 0.03 a | 3.81 ± 0.02 a |
| Lactoprotein | 2.48 ± 0.49 b | 4.08 ± 0.42 a | 3.86 ± 0.46 a |
| (%) | | | |
| Lactose (%) | 4.43 ± 0.25 a | 4.46 ± 0.23 a | 4.45 ± 0.21 a |
| Dry matter (%) | 13.05 ± 0.89 a | 15.33 ± 0.96 a | 15.19 ± 0.98 a |
| Nonfat solid | 8.71 ± 0.47 a | 9.32 ± 0.55 a | 9.15 ± 0.51 a |
| (%) | | | |
| Freezing point | 0.54 ± 0.03 a | 0.54 ± 0.02 a | 0.54 ± 0.02 a |
| (° C.) | | | |

It can be seen from the data in Table 3 and Table 4 that the feed additive of the present invention has no side effects on the quality of milk from cows, and the contents of milk fat and lactoprotein of the test groups are significantly higher than those of the control group. The milk yield of the test groups is significantly higher than that of the control group in the middle and last stages, while the effect of the test group 2 without maca powder is inferior to that of the test group 1 in the last stage but still prior to that of the control group.

In addition, researches show that the maca powder may increase the appetite of cows and improve the disease resistances of cows, but excessive maca powder will excite the cows and reduce the milk yield. Therefore, in the present invention, 0-1 part of maca powder is reasonably formulated with other components, so that the cost of feed is reasonably controlled, and the milk yield of cows is greatly increased, thereby realizing remarkable benefits.

By using the feed additive containing biogas residues for cows provided by the present invention, the conversion ratio of feed is improved, and the contents of milk fat and lactoprotein of cows are also improved in comparison to the conventional feed for cows. It is also found during the feeding process that, the cows in the test groups have high degree of health and high degree of activity, while the cows in the control group are relatively inferior. The biogas residues produced from anaerobic fermentation of distillers' grains are easier to be uptake and utilized by animals, and the waste biogas residues, apple pomace and radix astragali residues are recycled, so the utilization ratio of resources is improved, and it is advantageous for environmental protection and ecological cycle.

Mixed in proper proportion, the components in the present invention have the effects of nourishing blood, clearing and activating the channels and collaterals, promoting lactation and improving immunity. Due to multiple nutrients and biological activity, the appetite of cows is promoted and the digestive absorption and metabolism of cows are improved, so that the lactation efficiency of cows is improved, and there is long-term aftereffect onto the adjustment of cows.

The foregoing embodiments are merely preferred solutions of the present invention, and are not intended to limit the present invention in any form. Other variations and modifications may be further made without departing from the technical solutions defined by the claims.

1. A feed additive containing biogas residues for cows, characterized in that the feed additive for cows is prepared by mixing the following components in parts by weight:
20-50 parts of biogas residues,
15-28 parts of radix astragali residues,
10-12 parts of apple pomace,
3-6 parts of purple perilla,
4-8 parts of eucommia leaves,
3-8 parts of purslane, and
0-1 part of maca powder;
the biogas residues are resulting products from anaerobic fermentation of distillers' grains left by using cassava or sweet potatoes as raw materials for fermentation, and are then moisture removed by mechanical extrusion, dried by exposure to the sun and finally crushed by a crusher for use.

2. The feed additive containing biogas residues for cows according to claim 1, characterized in that the feed additive for cows is prepared by mixing the following components in parts by weight: 48 parts of biogas residues, 25 parts of radix astragali residues, 10 parts of apple pomace, 6 parts of purple perilla, 8 parts of eucommia leaves, 6 parts of purslane and 0.5 parts of maca powder.

3. The feed additive containing biogas residues for cows according to claim 1, characterized in that the feed additive for cows is prepared by mixing the following components in parts by weight: 37 parts of biogas residues, 28 parts of radix astragali residues, 12 parts of apple pomace, 4 parts of purple perilla, 6 parts of eucommia leaves, 8 parts of purslane and 1 part of maca powder.

4. A method for preparing the feed additive containing biogas residues for cows according to claim 1, including the following steps of:
a. mixing in proportion and then crushing the purple perilla, eucommia leaves and purslane, controlling the granularity below 10 mm, and baking or air-drying until the water content is lower than 12%; and
b. mixing the mixture obtained in step a with the biogas residues, radix astragali residues and apple pomace, dying and then adding the maca powder to obtain the product.

5. An application of the feed additive containing biogas residues for cows according to claim 1 in manufacturing feed for enhancing the immunity of livestock.
